(19) United States
(12) Patent Application Publication
(10) Pub. No.: US 2016/0285674 A1
(43) Pub. Date: Sep. 29, 2016

(54) INFORMATION PROCESSING APPARATUS, INFORMATION PROCESSING METHOD, AND DATA CENTER SYSTEM

(71) Applicant: FUJITSU LIMITED, Kawasaki-shi (JP)

(72) Inventor: Masayuki Wakita, Yokohama (JP)

(73) Assignee: FUJITSU LIMITED, Kawasaki-shi (JP)

(21) Appl. No.: 15/001,293

(22) Filed: Jan. 20, 2016

(30) Foreign Application Priority Data
Mar. 23, 2015 (JP) 2015-059640

(51) Int. Cl. H04L 12/24

(52) U.S. Cl. CPC H04L 41/0631

(57) ABSTRACT

A data center system includes an information processing apparatus and a plurality of data centers. The information processing apparatus includes a detection unit, a storage unit, and an extraction unit. The detection unit detects a fault in a system operated in each of the data centers. The storage unit stores fault-handling information regarding a handling method of a fault that occurred in a past. The extraction unit extracts, when the fault-handling information includes information regarding the handling method which is adapted in the past to address the detected fault occurred in a first data center among the data centers, the information regarding the handling method. Otherwise, the extraction unit extracts information regarding the handling method which is adapted in the past to address the detected fault occurred in a second data center other than the first data center.

### CROSS-REFERENCE TO RELATED APPLICATION(S)

This application is based upon and claims the benefit of priority of the prior Japanese Patent Application No. 2015-059640, filed on Mar. 23, 2015, the entire contents of which are incorporated herein by reference.

### FIELD

The embodiment discussed herein is related to an information processing apparatus, an information processing program, an information processing method, and a data center system.

### BACKGROUND

Conventionally, techniques have been provided to monitor devices, such as a computer, and operated systems, and when a fault occurs in such a device or system to be monitored, to handle the occurred fault. Conventional handling of a fault includes, after detection of the fault, collecting and analyzing information such as log information of the device or the like in which the fault occurs to perform handling. Systems a specific operation manager (engineer) handles are also limited to some extent. Regarding the conventional techniques, see Japanese Laid-open Patent Publication No. 11-346266 and Japanese Laid-open Patent Publication No. 2002-230672, for example.

Meanwhile, when a fault occurs in a data center system that includes a plurality of data centers, it may be difficult for conventional techniques to appropriately present a handling method of the occurred fault. For example, when an unknown fault occurs in each of the data centers, it is difficult to appropriately present a handling method of the occurred unknown fault. Therefore, there is a problem that handling of the fault that occurs in the data center needs time.

### SUMMARY

According to an aspect of an embodiment, an information processing apparatus includes a detection unit, a storage unit, and an extraction unit. The detection unit detects a fault that occurs in a first data center among a plurality of data centers placed in a plurality of locations, the plurality of data centers being communicative with each other. The storage unit stores fault-handling information regarding a handling method of a fault that occurred in a past. The extraction unit extracts, when the fault-handling information includes information regarding the handling method which is adapted in the past to address the detected fault occurred in the first data center, the information regarding the handling method. The extraction unit extracts, when the fault handling information does not include the information regarding the handling method, information regarding the handling method which is adapted in the past to address the detected fault occurred in a second data center which is one of the plurality of data centers other than the first data center.

According to another aspect of an embodiment, a non-transitory computer-readable recording medium having stored therein a program. The program causes a computer to execute a process. The process includes: detecting a fault that occurs in a first data center among a plurality of data centers placed in a plurality of locations, the plurality of data centers being communicative with each other; extracting from fault-handling information stored in a storage unit regarding a handling method of a fault that occurred in a past, when the fault-handling information includes information regarding the handling method which is adapted in the past to address the detected fault occurred in the first data center, the information regarding the handling method; and extracting from the fault-handling information, when the fault-handling information does not include the information regarding the handling method, information regarding the handling method which is adapted in the past to address the detected fault occurred in a second data center which is one of the plurality of data centers other than the first data center.

According to still another aspect of an embodiment, an information processing method causes a computer to execute a process. The process includes: detecting a fault that occurs in a first data center among a plurality of data centers placed in a plurality of locations, the plurality of data centers being communicative with each other; extracting from fault-handling information stored in a storage unit regarding a handling method of a fault that occurred in a past, when the fault-handling information includes information regarding the handling method which is adapted in the past to address the detected fault occurred in the first data center, the information regarding the handling method; and extracting from the fault-handling information, when the fault-handling information does not include the information regarding the handling method, information regarding the handling method which is adapted in the past to address the detected fault occurred in a second data center which is one of the plurality of data centers other than the first data center.

According to still another aspect of an embodiment, a data center system includes a plurality of data centers and an information processing apparatus. The plurality of data centers are placed in a plurality of locations and communicative with each other. The information processing apparatus includes a detection unit, a storage unit, and an extraction unit. The detection unit detects a fault that occurs in a system that is operated in each of the plurality of data centers. The storage unit stores fault-handling information regarding a handling method of a fault that occurred in a past. The extraction unit extracts, when the fault-handling information stored in the storage unit includes information regarding the handling method which is adapted in the past to address the detected fault occurred in a first data center among the plurality of data centers, the information regarding the handling method. The extraction unit extracts, when the fault-handling information does not include the information regarding the handling method, information regarding the handling method which is adapted in the past to address the detected fault occurred in a second data center which is one of the plurality of data centers other than the first data center.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of a data center system according to an embodiment;

FIG. 2 is a diagram illustrating a functional configuration of a data center according to the embodiment;

FIG. 3 is a diagram illustrating an example of data structure of fault-handling information;

FIG. 4 is a diagram illustrating an example of the data structure of the fault-handling information;

FIG. 5 is a diagram illustrating an example of data structure of technical level information;

FIG. 6 is a diagram illustrating an example of the data structure of the technical level information;

FIG. 7 is a diagram illustrating an example of data structure of engineer information;

FIG. 8 is a diagram illustrating an example of data structure of retained skill information;

FIG. 9 is a sequence diagram illustrating an example of a procedure of fault-handling processing; and

FIG. 10 is a diagram illustrating a computer that executes an information processing program.

### DESCRIPTION OF EMBODIMENT

Preferred embodiments of the present invention will be explained with reference to accompanying drawings. The present embodiment does not limit this invention. Each embodiment may be combined as appropriate, provided no contradictions arise in the processing.

Configuration of a Data Center System According to the Embodiment

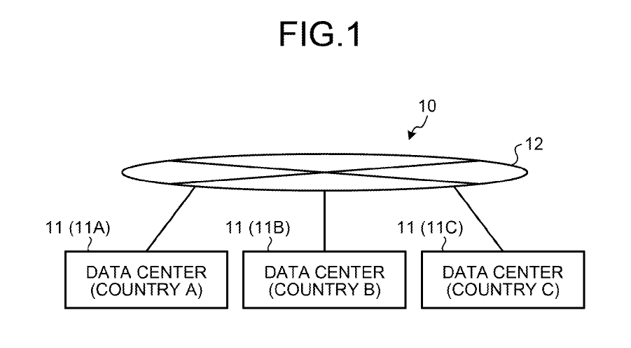

FIG. 1 is a diagram illustrating a hardware configuration of a data center system according to the embodiment. As illustrated in FIG. 1, a data center system 10 includes a plurality of data centers (DC) 11. The plurality of data centers 11 are each connected via a network 12. The network 12 may be a private line, and does not need to be a private line. Although an example of FIG. 1 illustrates three data centers 11 (11A, 11B, 11C), the number of data centers 11 may be an arbitrary number as long as the number is two or more.

Respective data centers 11 are placed at geographically distant locations. In the present embodiment, respective data centers 11 shall be placed, for example, in different areas such as different countries. In the example described below, one data center 11 is placed in one area. Specifically, in the example described below, the data center 11A shall be placed in a country A, the data center 11B shall be placed in a country B, and the data center 11C shall be installed in a country C. Two or more of the plurality of data centers 11 may be installed in an identical country. The following describes an example in which a data center ID “DC01” is assigned to the data center 11A as identification information for identifying the data center. In the following example, a data center ID “DC02” is assigned to the data center 11B, and a data center ID “DC03” is assigned to the data center 11C.

Hardware Configuration of the Data Center

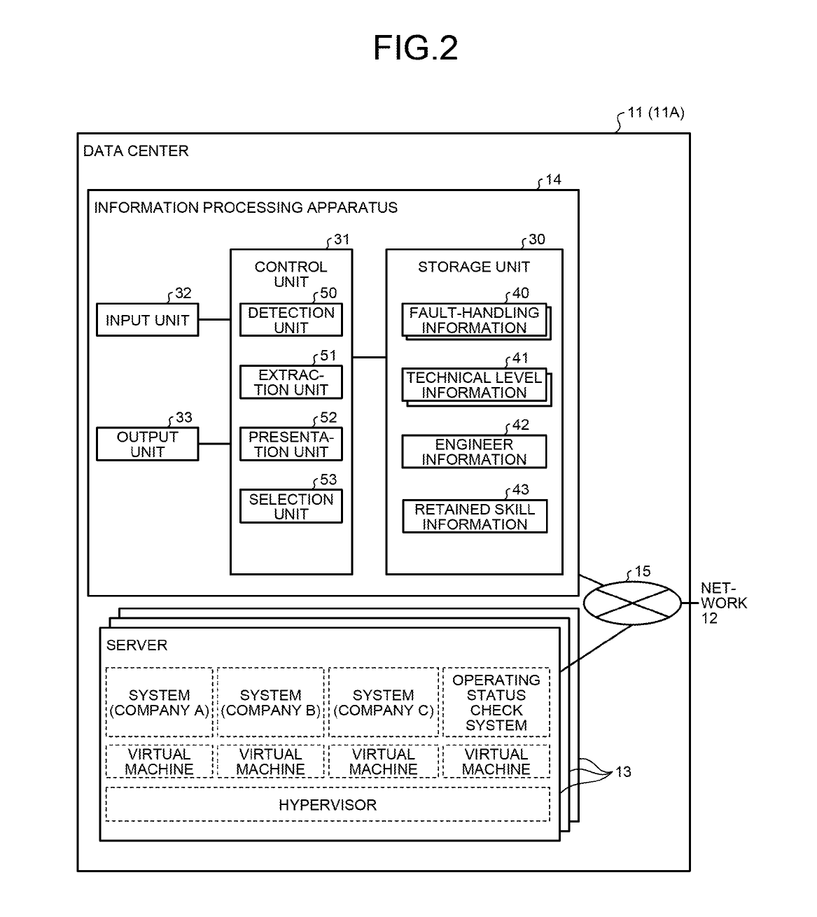

Next, a functional configuration of the data center 11 will be described with reference to FIG. 2. FIG. 2 is a diagram illustrating the functional configuration of the data center according to the embodiment. Since functional configurations of the data centers 11A to 11C are generally identical, the following describes an example of the configuration of the data center 11A.

The data center 11 includes a plurality of servers 13 and an information processing apparatus 14. The plurality of servers 13 and the information processing apparatus 14 are connected over a network 15, and may communicate. This network 15 is connected communicatively to the network 12, and may communicate with other data centers 11 via the network 12. Although the example of FIG. 2 illustrates three servers 13, arbitrary number of servers 13 may be included. Although the example of FIG. 2 illustrates one information processing apparatus 14, two or more information processing apparatuses 14 may be included.

The servers 13 are each a physical server that operates a virtual machine obtained by virtualizing a computer to provide various services to a user, and is, for example, a server computer. The servers 13 each execute a server virtualization program to operate a plurality of virtual machines on a hypervisor, and operate application programs according to customers on the virtual machines to operate customer systems, respectively. In the present embodiment, systems of various companies are operating as the customer systems. In the example of FIG. 2, systems of a company A, a company B, and a company C are operating as the customer systems. The servers 13 each operate, for example, the virtual machines and operate an operating status check system on the virtual machine. This operating status check system may be a dedicated system for checking an operating status of the data center 11, and a management system that manages the data center 11 may serve as the operating status check system.

The information processing apparatus 14 is a physical server that detects a fault that occurs in the data center 11 and presents a handling method of the occurred fault, and is, for example, a server computer. For example, the information processing apparatus 14 detects a fault that occurs in each server 13 or the like, and presents the handling method of the occurred fault.

The information processing apparatuses 14 of respective data centers 11 may transmit and receive information with each other, and may grasp a situation of other data centers 11 based on information from the information processing apparatuses 14 of other data centers 11. The data center system 10 operates one of the information processing apparatuses 14 of respective data centers 11 as the information processing apparatus that manages the entire data center system 10. The information processing apparatuses 14 of other data centers 11 notify the situation within the data centers 11 to the information processing apparatus 14 that is specified as the information processing apparatus that manages the entire data center system 10. For example, each of the information processing apparatuses 14 has a master-slave relationship with the information processing apparatuses 14 of other data centers 11. The master-slave relationship between the information processing apparatuses may be set by an administrator in advance, and may be set by a program in accordance with a predetermined setting procedure. The master information processing apparatus 14 may be changed every predetermined period of time.

The slave information processing apparatus 14 notifies the situation within the data center 11 to the master information processing apparatus 14. For example, the slave information processing apparatus 14 transmits a log, etc. of a fault that occurs in the data center 11 to which the slave information processing apparatus 14 belongs, to the master information processing apparatus 14. The master information processing apparatus 14 may reference information regarding the fault that occurs in the data center 11 to which the slave information processing apparatus 14 belongs, including the fault log and the handling method of the fault. If the master information processing apparatus 14 is allowed to make reference, the information regarding the fault that occurs in another data center 11 to which the slave information processing apparatus 14 belongs, such as the fault log and the handling method of the fault, may be distributed in each slave information processing apparatus 14.

The master information processing apparatus 14 notifies an instruction in connection with an operation of the data center 11 to the slave information processing apparatuses 14 of other data centers 11. For example, the master information processing apparatus 14 transmits the handling method of the occurred fault to the slave information processing apparatuses 14 of other data centers 11. The slave information processing apparatuses 14 present the handling method received from the master information processing apparatus 14. Here, the information processing apparatus 14 that serves as the master of the master-slave relationship shall be referred to as “lead”. The following describes the information processing apparatus 14 of the data center 11A as “lead”.

### Configuration of the Information Processing Apparatus

Next, a configuration of the information processing apparatus 14 according to the embodiment will be described. As illustrated in FIG. 2, the information processing apparatus 14 includes a storage unit 30, a control unit 31, an input unit 32, and an output unit 33. The information processing apparatus 14 may also include various functional units that a known computer includes, other than functional units illustrated in FIG. 2.

The input unit 32 is, for example, a keyboard, mouse, etc., and accepts various operations by a user. The output unit 33 is, for example, a display device such as a liquid crystal display, a voice output device, and a printing device, and outputs various pieces of information.

The storage unit 30 is a storage device that stores various pieces of data. For example, the storage unit 30 is a storage apparatus such as a hard disk, SSD (Solid State Drive), and optical disc. The storage unit 30 may be a data-rewritable semiconductor memory such as a RAM (Random Access Memory), flash memory, and NVSRAM (Non Volatile Static Random Access Memory).

The storage unit 30 stores an OS (Operating System) and various programs to be executed by the control unit 31. For example, the storage unit 30 stores various programs including a program that executes fault-handling processing described later. Furthermore, the storage unit 30 stores various pieces of data used by a program executed by the control unit 31. For example, the storage unit 30 stores fault-handling information 40, technical level information 41, engineer information 42, and retained skill information 43.

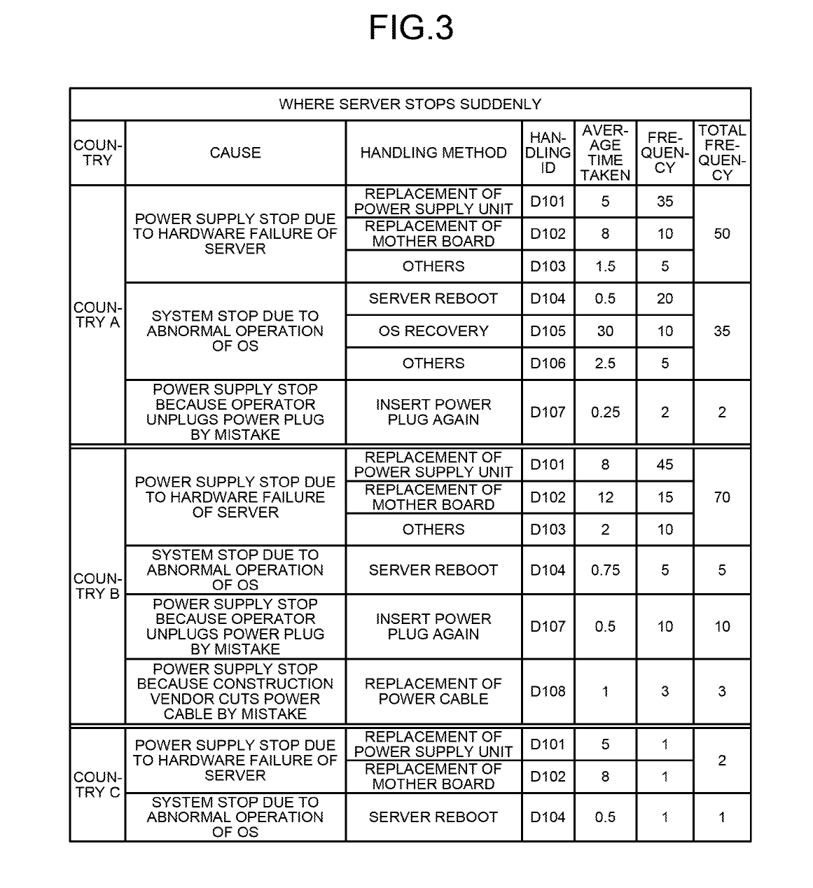

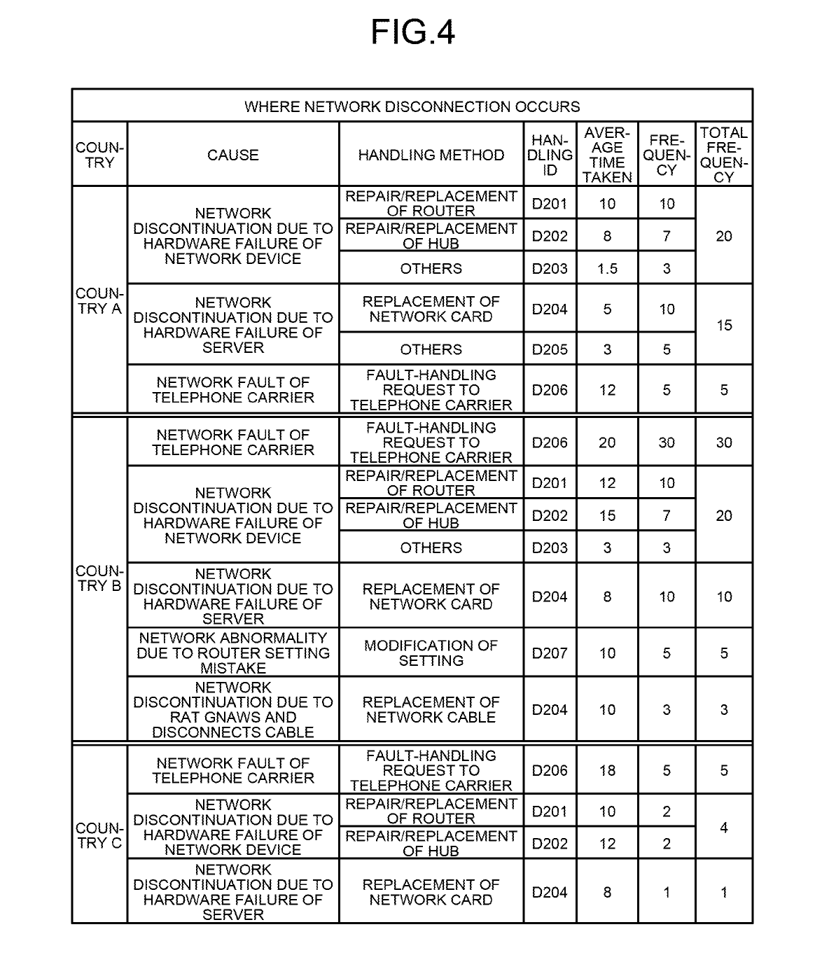

The fault-handling information 40 is data that stores information regarding the handling method of the fault that occurs in the data center system 10. For example, information on the handling method of each fault in each country is stored in the fault-handling information 40. For example, as illustrated in FIG. 3 and FIG. 4, the information on the handling method in each country is classified into tables for respective faults and is stored.

FIG. 3 is a diagram illustrating an example of data structure of the fault-handling information. Specifically, FIG. 3 illustrates an example of the data structure of the fault-handling information in each country in a case where the fault is “the server stops suddenly”.

As illustrated in FIG. 3, the fault-handling information 40 has items of “country”, “cause”, “handling method”, “handling ID”, “average time taken”, “frequency”, and “total frequency”. The item of country is a field that stores information on a country in which the data center 11 is located in which the fault occurs in the data center system 10. Although country names including the “country A”, “country B”, and “country C” are stored as country information in the example illustrated in FIG. 3, a country ID assigned to each country as identification information may be stored.

The item of cause is a field that stores information indicating a cause of the occurred fault. In the example illustrated in FIG. 3, information indicating the cause of the fault “the server stops suddenly” is stored in the item of cause. In the example illustrated in FIG. 3, as the information indicating the cause, causes such as “power supply stop due to a hardware failure of the server” and “system stop due to an abnormal operation of OS” are stored. Here, in the item of cause, a cause ID assigned to each cause as identification information may be stored.

The item of handling method is a field that stores information indicating the handling method of the occurred fault. In the example illustrated in FIG. 3, information indicating the handling method when the fault “the server stops suddenly” occurs is stored. In the example illustrated in FIG. 3, as the information indicating the handling method, the handling method such as “replacement of the power supply unit” and “replacement of the mother board” is stored. The item of handling ID is a field that stores the handling ID assigned to each handling method as identification information. In the example illustrated in FIG. 3, the handling ID assigned to the handling method when the fault “the server stops suddenly” occurs is stored. For example, the handling ID “D101” is assigned to the handling method “replacement of the power supply unit”.

The item of average time taken is a field that stores information indicating an average of time taken when the handling method of the occurred fault is performed. In the example illustrated in FIG. 3, information is stored indicating the average time taken in performing each handling method when the fault “the server stops suddenly” occurs. The item of frequency is a field that stores information indicating frequency of performing the handling method of the occurred fault. In the example illustrated in FIG. 3, information is stored indicating the frequency of performing each handling method when the fault “the server stops suddenly” occurs. The item of total frequency is a field that stores information obtained by totaling the frequency of performing each handling method for each cause. In the example illustrated in FIG. 3, information is stored indicating the sum of frequency of performing each handling method for each cause such as “power supply stop due to a hardware failure of the server”.

The example of FIG. 3 illustrates that the cause of occurrence of the fault “the server stops suddenly” in the country A includes three causes: “power supply stop due to a hardware failure of the server”, “system stop due to an abnormal operation of OS”, and “power supply stop because an operator unplugs a power plug by mistake”. When the cause in the country A is “power supply stop due to a hardware failure of the server”, the example of FIG. 3 illustrates experience of performing three handling methods: D101 “replacement of the power supply unit”, D102 “replacement of the mother board”, and D103 “others”. The example of FIG. 3 illustrates that D101 “replacement of the power supply unit” is performed 35 times in the country A, and that the average time taken with the replacement is 5 hours. The example of FIG. 3 illustrates that D102 “replacement of the mother board” is performed 10 times in the country A, and that the average time taken with the replacement is 8 hours. The example of FIG. 3 illustrates that, when the cause is “power supply stop due to a hardware failure of the server” in the country A, the sum of frequency of performing the handling is 50 times.

FIG. 4 is a diagram illustrating an example of the data structure of the fault-handling information. Specifically, FIG. 4 illustrates an example of the data structure of the fault-handling information in each country when the fault is “network discontinuation occurs”.

In the example illustrated in FIG. 4, the country names including the “country A”, “country B”, and “country C” are stored as country information. In the example illustrated in FIG. 4, as the information indicating the cause, causes such as “network discontinuation due to a hardware failure of the network device” and “network discontinuation due to a hardware failure of the server” are stored. In the example illustrated in FIG. 4, as the information indicating the handling method, the handling method such as “repair/replacement of the router” and “repair/replacement of the hub” is stored. In the example illustrated in FIG. 4, the handling ID assigned to the handling methods when the fault “network discontinuation occurs” occurs is stored. For example, the handling ID “D201” is assigned to the handling method “repair/replacement of the router”. In the example illustrated in FIG. 4, information is stored indicating the average time taken in performing each handling method when the fault “network discontinuation occurs” occurs. In the example illustrated in FIG. 4, information is stored indicating the frequency of performing each handling method when the fault “network discontinuation occurs” occurs. For each cause such as “network discontinuation due to a hardware failure of the network device”, information indicating the sum of frequency of performing each handling method is stored.

The example of FIG. 4 illustrates that the cause of occurrence of the fault “network discontinuation occurs” in the country A includes three causes: “network discontinuation due to a hardware failure of the network device”, “network discontinuation due to a hardware failure of the server”, and “network fault of a telephone carrier”. When the cause in the country A is “network discontinuation due to a hardware failure of the network device”, the example of FIG. 4 illustrates experience of performing three handling methods: D201 “repair/replacement of the router”, D202 “repair/replacement of the hub”, and D203 “others”. The example of FIG. 4 illustrates that D201 “repair/replacement of the router” is performed 10 times in the country A, and that the average time taken with the repair/replacement is 10 hours. The example of FIG. 4 illustrates that D202 “repair/replacement of the hub” is performed 7 times in the country A, and that the average time taken with the repair/replacement is 8 hours. The example of FIG. 4 illustrates that, when the cause is “network discontinuation due to a hardware failure of the network device” in the country A, the sum of frequency of performing the handling is 20 times.

The fault-handling information 40 may, for each individual fault that occurs in the data center system 10, store information such as a storage place of a file describing the fault and handling method, a status indicating a situation of handling the fault, and information on an engineer who handles the fault, in association with each fault, each cause, or each handling method. As the handling ID, different handling IDs for respective countries may be assigned even if the handling methods are identical. As the handling ID, when the handling methods are similar, an identical handling ID may be assigned to the similar handling methods. When the handling methods are similar, the handling IDs of the similar handling methods may be associated and stored. As the handling ID, when the handling methods are identical, an identical handling ID may be assigned between a plurality of faults and between a plurality of causes. Information indicating the average time taken in performing the handling methods for each cause may be stored. Information indicating the average time taken in performing the handling methods for each country may be stored.

Although the present embodiment describes the example of storing the handling method for each country as illustrated in FIG. 3 and FIG. 4 because one data center 11 is placed in each country, when a plurality of data centers 11 are placed in each country, the handling method may be stored for each data center 11.

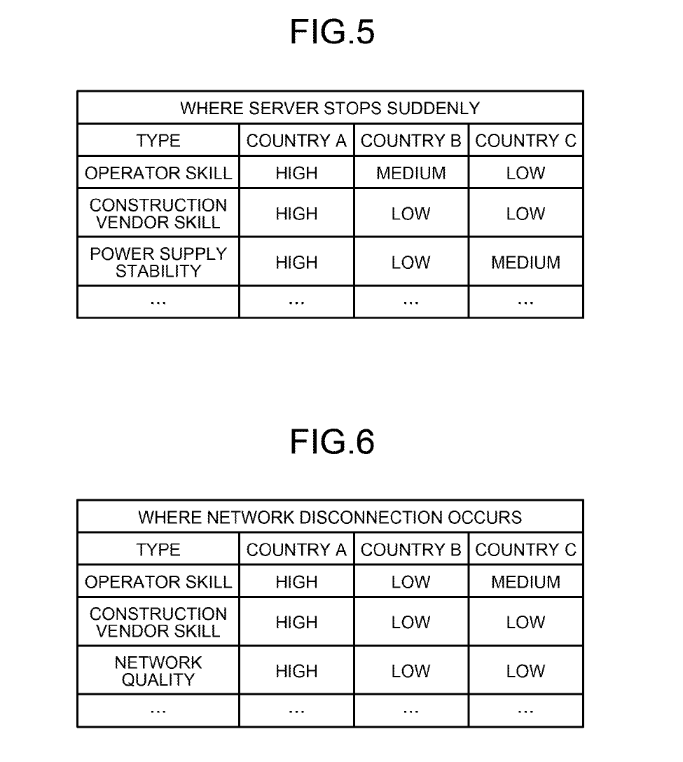

The technical level information 41 is data that stores information indicating a skill level of an engineer, environmental condition, and the like (hereinafter referred to as “technical level”) for each country in the data center system 10. For example, the information indicating the technical level in each country for each fault is stored in the technical level information 41. For example, as illustrated in FIG. 5 and FIG. 6, the information indicating the technical level in each country are classified into tables for respective faults and is stored.

FIG. 5 is a diagram illustrating an example of data structure of the technical level information. Specifically, FIG. 5 illustrates an example of the data structure of the technical level information in each country when the fault is “the server stops suddenly”.

As illustrated in FIG. 5, the technical level information 41 includes items of “type”, “country A”, “country B”, and “country C”. The item of type is a field that stores information indicating the type of estimating the technical level in each country included in the data center system 10. In the example illustrated in FIG. 5, the types such as “operator skill”, “construction vendor skill”, and “power supply stability” are stored as the type. For example, in the example illustrated in FIG. 5, “operator skill” and “construction vendor skill” are types indicating the skill level of engineers in each country, and “power supply stability” is a type indicating environment in each country. The type is not limited to the aforementioned three types, and various types may be stored according to an object. In the item of type, a type ID assigned to each type as identification information may be stored.

The item of country A is a field that stores a predetermined evaluation value for each type in the country A. In the example illustrated in FIG. 5, three evaluation values of “high”, “medium”, and “low” are stored as the predetermined evaluation value. The example illustrated in FIG. 5 illustrates that, about the country A, all the three types of “operator skill”, “construction vendor skill”, and “power supply stability” are “high”.

The item of country B is a field that stores a predetermined evaluation value for each type in the country B. The example illustrated in FIG. 5 illustrates that, about the country B, one type of “operator skill” is “medium”, and two types of “construction vendor skill” and “power supply stability” are “low”. The item of country C is a field that stores a predetermined evaluation value for each type in the country C. The example illustrated in FIG. 5 illustrates that, about the country C, two types of “operator skill” and “construction vendor skill” are “low”, and one type of “power supply stability” is “medium”.

FIG. 6 is a diagram illustrating an example of the data structure of the technical level information. Specifically, FIG. 6 illustrates an example of the data structure of the technical level information in each country when the fault is “network discontinuation occurs”.

In the example illustrated in FIG. 6, the types such as “operator skill”, “construction vendor skill”, and “network quality”, are stored as the type. For example, in the example illustrated in FIG. 6, “operator skill” and “construction vendor skill” are the types indicating the skill level of engineers in each country, and “network quality” is the type indicating environment in each country.

The example illustrated in FIG. 6 illustrates that, about the country A, all the three types of “operator skill”, “construction vendor skill”, and “network quality” are “high”. The example illustrated in FIG. 6 illustrates that, about the country B, all the three types of “operator skill”, “construction vendor skill”, and “network quality” are “low”. The example illustrated in FIG. 6 illustrates that, about the country C, one type of “operator skill” is “medium”, and two types of “construction vendor skill” and “network quality” are “low”.

Although the present embodiment describes the example of storing the technical level for each country as illustrated in FIG. 5 and FIG. 6 because one data center 11 is placed in each country, when the plurality of data centers 11 are placed in each country, the technical level may be stored for each data center 11.

The engineer information 42 is data that stores information regarding an engineer registered in the data center system 10. For example, the engineer information 42 is data that stores information regarding the engineer who belongs to each data center. For example, the engineer information 42 stores information such as an engineer ID, name, contact address of the engineer, activity time of the engineer, data center to which the engineer belongs, and country to which the engineer belongs.

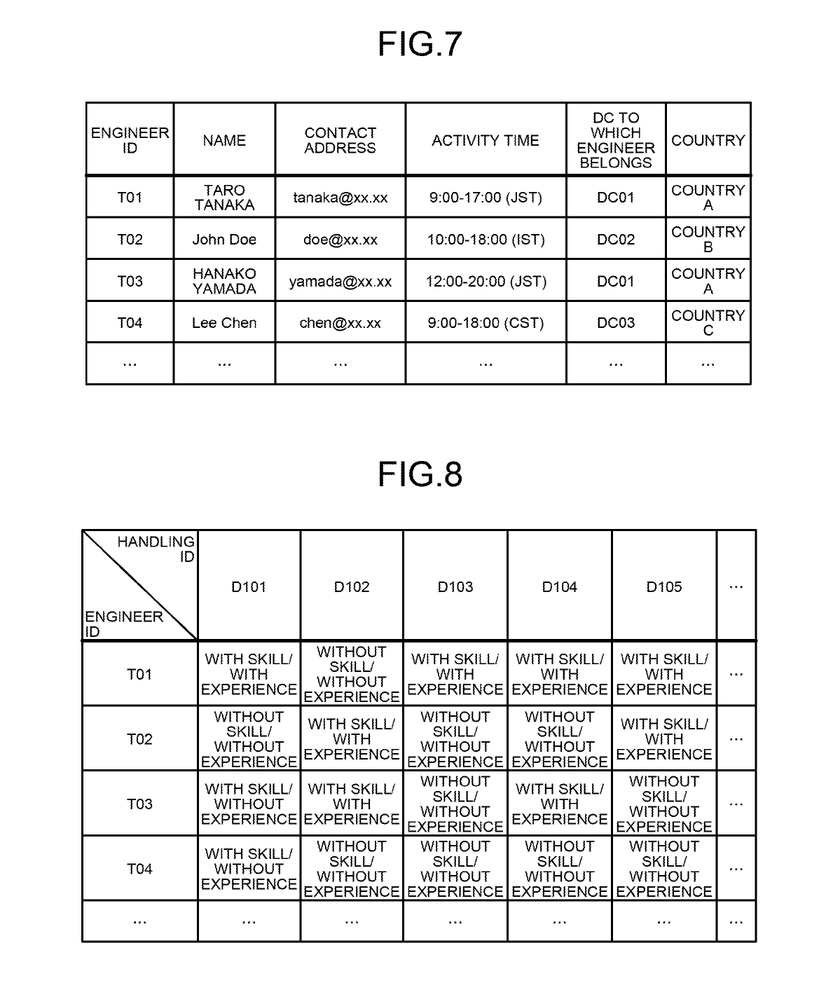

FIG. 7 is a diagram illustrating an example of data structure of the engineer information. As illustrated in FIG. 7, the engineer information 42 includes items of “engineer ID”, “name”, “contact address”, “activity time”, “DC to which the engineer belongs”, and “country”. The item of engineer ID is a field that stores identification information for identifying the engineer registered in the data center system 10. The engineer ID is assigned to the engineer registered in the data center system 10 as the identification information for identifying each engineer. The engineer ID assigned to the engineer registered in the data center system 10 is stored in the item of engineer ID. The item of name is a field that stores a name of the engineer identified with the engineer ID. The item of contact address is a field that stores a contact address of the engineer identified with the engineer ID (for example, email address, telephone number, and the like). The item of activity time is a field that stores time during which the engineer identified with the engineer ID is engaged in work. The item of DC to which the engineer belongs is a field that stores a data center ID that identifies the data center to which the engineer identified with the engineer ID belongs. The item of country is a field that stores a country to which the engineer identified with the engineer ID belongs. The engineer information 42 is not limited to the above-described information, but may also include various pieces of information such as information regarding days off of the engineer, for example.

The example of FIG. 7 illustrates that, regarding the engineer identified with “T01”, the name is “Taro Tanaka”, the contact address is “tanaka@xx.xx”, and the activity time is 9:00 to 17:00 (JST). In addition, the example of FIG. 7 illustrates that, regarding the engineer identified with “T01”, the data center ID of the data center to which the engineer belongs is “DC01”, and that the country to which the engineer belongs is the “country A”. Here, “JST” in a column of the “activity time” in FIG. 7 means the Japan Standard Time, “IST” means the Indian standard time, and “CST” means the Chinese Standard Time.

The retained skill information 43 is data that stores information regarding the skill that the engineer registered in the data center system 10 has. For example, the retained skill information 43 stores information such as whether each engineer has a skill regarding various OSs for each fault, whether each engineer has a skill regarding various services, and whether each engineer has a skill regarding various networks.

FIG. 8 is a diagram illustrating an example of data structure of the retained skill information. As illustrated in FIG. 8, the retained skill information 43 illustrates presence of skill and experience of each engineer regarding each handling method. In the example illustrated in FIG. 8, the retained skill information 43 has items of “engineer ID”, “D101”, “D102”, “D103”, “D104”, “D105”, and the like. The item of engineer ID, which is the leftmost item of FIG. 8, is a field that stores the engineer ID assigned to the engineer registered in the data center system 10. The item of D101 is a field that stores information whether the engineer identified with the engineer ID has a skill such as a skill regarding the handling method identified with D101. The item of D102 is a field that stores information whether the engineer identified with the engineer ID has a skill such as a skill regarding the handling method identified with D102. The item of D103 is a field that stores information whether the engineer identified with the engineer ID has a skill such as a skill regarding the handling method identified with D103. The item of D104 is a field that stores information whether the engineer identified with the engineer ID has a skill such as a skill regarding the handling method identified with D104. The item of D105 is a field that stores information whether the engineer identified with the engineer ID has a skill such as a skill regarding the handling method identified with D105.

The example of FIG. 8 illustrates that the engineer identified with T01 has a skill and experience of the handling method identified with D101, and that the engineer does not have a skill and experience of the handling method identified with D102. Specifically, the engineer identified with T01 has the skill and experience of the handling method “replacement of the power supply unit” identified with D101. The engineer identified with T01 does not have the skill and experience of the handling method “replacement of the mother board” identified with D102. The example of FIG. 8 illustrates that the engineer identified with T01 has skills and experience regarding D103 to D105. Specifically, the example of FIG. 8 illustrates that the engineer identified with T01 has the skills and experience of the handling methods of “others”, “server reboot”, and “OS recovery” identified with D103 to D105, respectively.

Returning to FIG. 2, the control unit 31 is a device that controls the information processing apparatus 14. As the control unit 31, electronic circuitry, such as a CPU (Central Processing Unit) and an MPU (Micro Processing Unit), and an integrated circuit, such as an ASIC (Application Specific Integrated Circuit) and an FPGA (Field Programmable Gate Array), may be employed. The control unit 31 includes an internal memory for storing a program that prescribes various processing procedures and control data, and executes various processes with these program and control data. The control unit 31 functions as various processors by the various programs running. For example, the control unit 31 includes a detection unit 50, an extraction unit 51, a presentation unit 52, and a selection unit 53.

The detection unit 50 detects a fault that occurs in the data center 11. For example, the detection unit 50 detects an operating status of the data center 11. For example, as the operating status of the data center 11, the detection unit 50 detects a status of occurrence of a fault in the operating status check system which checks the operating status of the data center 11. For example, the detection unit 50 detects whether a fault has occurred from information such as a log and thermal error of BIOS (Basic Input Output System) of the server 13 in which the operating status check system operates, an event log of OS of the virtual machine, and a monitoring ALARM message. The detection unit 50 determines whether the occurred fault is a fault regarding hardware, or is a fault regarding software. For example, based on the BIOS log or the event log of the virtual machine OS described above, the detection unit 50 may determine whether the occurred fault is stop of the server 13, network discontinuation, etc. The aforementioned determination of the occurred fault made by the detection unit 50 is illustrative. Based on various techniques, the detection unit 50 may determine what kind of fault the occurred fault is.

The lead information processing apparatus 14 acquires information regarding the occurred fault from the information processing apparatus 14 of each of other data centers 11. For example, the detection unit 50 of the information processing apparatus 14 in the data center 11A acquires the information regarding the occurred fault from the information processing apparatus 14 of each of other data centers 11. The information processing apparatus 14 of each of other data centers 11 may transmit this information regarding the occurred fault at any time when the fault occurs in the data center 11 or when handling of the fault is completed.

The extraction unit 51 extracts information regarding the handling method of the occurred fault. For example, based on the determination of the fault made by the detection unit 50, the extraction unit 51 extracts the information regarding the handling method of the occurred fault from the fault-handling information 40 in the storage unit 30. For example, when the fault that occurs in the data center 11 of the country A (hereinafter referred to as “country A”) is stop of the server 13, the extraction unit 51 extracts information corresponding to the country A from a table regarding stop of the server 13 out of the fault-handling information 40 in the storage unit 30. In the example illustrated in FIG. 3, the extraction unit 51 extracts information of which item of country is the “country A”. Specifically, in the example illustrated in FIG. 3, the extraction unit 51 extracts information regarding seven handling methods of D101 to D107 performed in the country A. Also, in the example illustrated in FIG. 3, when the fault that occurs in the country B is stop of the server 13, the extraction unit 51 extracts information regarding six handling methods of D101 to D104 and D107 to D108 performed in the country B. Also, in the example illustrated in FIG. 3, when the fault that occurs in the country C is stop of the server 13, the extraction unit 51 extracts information regarding three handling methods of D101, D102, and D104 performed in the country C.

Here, when the detection unit 50 also determines a cause of a fault, the extraction unit 51 may extract information corresponding to the cause of the fault determined by the detection unit 50. For example, when a fault that occurs in the country A is stop of the server 13 and a cause is power supply stop due to a hardware failure of the server 13, the extraction unit 51 extracts information corresponding to the cause in the country A from a table regarding stop of the server 13 out of the fault-handling information 40 in the storage unit 30. In the example illustrated in FIG. 3, the extraction unit 51 extracts information regarding three handling methods of D101 to D103 corresponding to the cause “power supply stop due to a hardware failure of the server” performed in the country A. Hereinafter, the information regarding the handling method extracted by the extraction unit 51 may be referred to as handling candidate information.

Based on the handling candidate information extracted by the extraction unit 51, when there is information regarding the handling method on occurrence of a fault in the past in the data center 11 in which a fault occurs, the presentation unit 52 presents the information regarding the handling method in the data center 11. For example, when there is information regarding the handling method on occurrence of the fault in the past in a country to which the data center 11 belongs in which the fault occurs, the presentation unit 52 presents the information regarding the handling method in the country to which the data center 11 belongs. The case mentioned here where there is information regarding the handling method on occurrence of the fault in the past may be a case where information regarding one or more handling methods is included, and may be a case where information regarding the handling method of equal to or greater than a predetermined threshold is included. The case mentioned here where the information regarding the one or more handling methods is included means a case where the sum of total frequency of the handling method of the country in the corresponding fault table is once or more. The following describes a case where the predetermined threshold is 10 times.

For example, when the sum of total frequency of the handling method included in the handling candidate information is equal to or greater than the predetermined threshold, the presentation unit 52 presents the handling method on occurrence of the fault in the past in the data center 11 in which the fault occurs. In the example illustrated in FIG. 3, when the fault that occurs in the country A is stop of the server 13, the sum of total frequency of the handling method included in the handling candidate information, which is (50+35+2=) 87 times, becomes equal to or greater than 10 times, which is the predetermined threshold. Therefore, the presentation unit 52 considers that there is information regarding the handling method on occurrence of the fault in the past in the data center 11 in which the fault occurs. Accordingly, the presentation unit 52 presents the handling method on occurrence of the fault in the past in the data center 11 in which the fault occurs.

Here, the presentation unit 52 may present all the handling methods included in the handling candidate information. For example, the presentation unit 52 may cause the output unit 33 to output all the handling methods included in the handling candidate information for presentation. The presentation unit 52 may present the handling method with frequency equal to or greater than the predetermined frequency among the handling methods included in the handling candidate information. In the example illustrated in FIG. 3, when the fault that occurs in the country A is stop of the server 13 and the predetermined frequency is 20 times, the presentation unit 52 presents the handling method of D101 and the handling method of D104. Specifically, the presentation unit 52 presents the handling method “replacement of the power supply unit” and the handling method “server reboot”. The presentation unit 52 may present the handling method with greatest frequency among the handling methods included in the handling candidate information. In the example illustrated in FIG. 3, when the fault that occurs in the country A is stop of the server 13, the presentation unit 52 presents the handling method of D101. Specifically, the presentation unit 52 presents the handling method “replacement of the power supply unit”.

Based on the handling candidate information extracted by the extraction unit 51, when there is no information regarding the handling method on occurrence of the fault in the past in the data center 11 in which the fault occurs, the presentation unit 52 presents information regarding the handling method on occurrence of the fault in the past in another data center 11. For example, when there is no information regarding the handling method on occurrence of the fault in the past in the country to which the data center 11 belongs in which the fault occurs, the presentation unit 52 presents information regarding the handling method in a country to which another data center 11 belongs. The case mentioned here where there is no information regarding the handling method on occurrence of the fault in the past may be a case where the information regarding the handling method is not included, and may be a case where the information regarding the handling method of less than the predetermined threshold is included.

For example, when the sum of total frequency of the handling method included in the handling candidate information is less than the predetermined threshold, the presentation unit 52 presents the handling method on occurrence of the fault in the past in another data center 11. In the example illustrated in FIG. 3, when the fault that occurs in the country C is stop of the server 13, the sum of total frequency of the handling method included in the handling candidate information, which is (2+1=) 3 times, becomes less than 10 times, which is the predetermined threshold. Therefore, the presentation unit 52 considers that there is no information regarding the handling method on occurrence of the fault in the past in the data center 11 in which the fault occurs. Accordingly, the presentation unit 52 presents the handling method on occurrence of the fault in the past in another data center 11.

When there is no information regarding the handling method on occurrence of the fault in the past in the data center 11 in which the fault occurs, the presentation unit 52 presents information in another data center 11 included in a country that has a technical level similar to a technical level of a country (area) to which the data center 11 belongs. Specifically, the presentation unit 52 presents information regarding the handling method on occurrence of the fault in the past in another data center 11 included in the country that has the technical level similar to the technical level of the country to which the data center 11 belongs in which the fault occurs. For example, when a fault that occurs in the country C is stop of the server 13, the presentation unit 52 determines a country that has the technical level similar to the technical level of the country C. At this time, based on the technical level that matches the fault among a plurality of technical levels that respectively match a plurality of faults, the presentation unit 52 determines the country that has the technical level similar to the technical level of the country in which the fault occurs. For example, out of the technical level information 41 illustrated in FIG. 5 and FIG. 6, the presentation unit 52 makes the determination based on the technical level information 41 regarding the fault “stop of the server” illustrated in FIG. 5.

Here, determination of a country similar to the country C will be described in the example illustrated in FIG. 5. In FIG. 5, three evaluation values of “high”, “medium”, and “low” are stored. Then, the presentation unit 52 determines a country whose evaluation value of each type resembles as the similar country. In the following, when the evaluation values are identical, a comparison value of each type is “0”. When a first evaluation value is “high” and a second evaluation value is “medium”, or when the first evaluation value is “medium” and the second evaluation value is “low”, the comparison value of each type is “1”. When the first evaluation value is “high” and the second evaluation value is “low”, the comparison value of each type is “2”. In this case, the presentation unit 52 determines that countries with small sum of comparison values in each type are similar. In the example illustrated in FIG. 5, a degree of similarity between the country C and the country A is “5” because the comparison value of the “operator skill” type is “2”, the comparison value of the “construction vendor skill” type is “2”, and the comparison value of the “power supply stability” type is “1”. On the other hand, the degree of similarity between the country C and the country B is “2” because the comparison value of the “operator skill” type is “1”, the comparison value of the “construction vendor skill” type is “0”, and the comparison value of the “power supply stability” type is “1”. That is, since the degree of similarity “2” between the country C and the country B is small compared with the degree of similarity “5” between the country C and the country A, the country C is determined to be similar to the country B. The presentation unit 52 may consider countries with degrees of similarity less than a predetermined degree of similarity as similar countries.

Therefore, the presentation unit 52 instructs the extraction unit 51 to extract the handling method for a case where the fault that occurs in the country B is stop of the server 13, as the handling candidate information. Then, the presentation unit 52 presents the handling method based on the handling candidate information for the case where the fault that occurs in the country B is stop of the server 13. The presentation unit 52 may present all the handling methods included in the handling candidate information. Among the handling methods included in the handling candidate information, the presentation unit 52 may present the handling method with frequency equal to or greater than the predetermined frequency. Among the handling methods included in the handling candidate information, the presentation unit 52 may present the handling method with greatest frequency. In the example illustrated in FIG. 3, the presentation unit 52 presents the handling method of D101 for a case where the fault that occurs in the country B is stop of the server 13. Specifically, the presentation unit 52 presents the handling method “replacement of the power supply unit”.

In the present embodiment, after the presentation unit 52 presents the handling method, the information processing apparatus 14 selects an engineer who handles the fault. For example, in response to instructions to perform automatic selection of an engineer issued using the input unit 32 by an operator who checks the handling method displayed on a liquid crystal display, which is the output unit 33, the information processing apparatus 14 may select the engineer who handles the fault. This will be described below.

After the presentation unit 52 presents the handling method, the selection unit 53 extracts an engineer who is capable of handling the occurred fault. For example, based on skills of engineers stored in the retained skill information 43 in the storage unit 30, the selection unit 53 extracts the engineer who is capable of handling the fault. For example, the extraction unit 51 selects an engineer who has experience of the handling method presented by the presentation unit 52 as the engineer who is capable of handling the fault. The following describes an example in which a fault that occurs at 12:00 (JST) in the country A is stop of the server 13, and the presentation unit 52 presents the handling method of D101 “replacement of the power supply unit”.

First, the selection unit 53 selects an engineer of the country A from the engineer information 42 in the storage unit 30. For example, in the example illustrated in FIG. 7, an engineer identified with the engineer ID of 101 (hereinafter referred to as engineer of 101), and an engineer identified with T03 (hereinafter referred to as engineer of T03) are selected. At this time, the selection unit 53 may extract only an engineer who is capable of handling the fault based on occurrence time of the fault, average time taken with the handling method, and activity time of each engineer. As described above, when the fault occurs at 12:00 (JST), the selection unit 53 determines that both the engineer of 101 and engineer of T03 are within the activity time and are capable of handling the fault. As illustrated in FIG. 3, since the average time taken with the handling method D101 in the country A is 5 hours, the selection unit 53 determines that both the engineer of 101 and engineer of T03 are capable of handling the fault within the activity time. The selection unit 53 may exclude an engineer who is determined to be not capable of handling the fault. The foregoing is an example of selection of an engineer based on time, and the selection unit 53 may select an engineer outside the activity time.

Next, the selection unit 53 selects one of two persons, the engineer of 101 and the engineer of T03, as the engineer who is capable of handling the fault. In the aforementioned example, since the handling method the presentation unit 52 presents is the handling method of D101 “replacement of the power supply unit”, the selection unit 53 selects an engineer who has experience of the handling method of D101. Here, as illustrated in FIG. 8, regarding the experience of the handling method of D101, the engineer of 101 has the experience, but the engineer of T03 does not have the experience. Accordingly, the selection unit 53 selects the engineer of 101 as the engineer who is capable of handling the fault of stop of the server 13 that occurs at 12:00 (JST) in the country A. Note that when there is no engineer who has experience of the handling method presented by the presentation unit 52, the selection unit 53 may select an engineer who has only skill of the handling method presented by the presentation unit 52. For example, when the engineer of 101 is not present, the selection unit 53 may select the engineer of T03 who has the skill of the handling method of D101.

Here, when the presentation unit 52 presents a plurality of handling methods, the selection unit 53 may extract an engineer who has experience equal to or greater than a predetermined number among the plurality of handling methods. For example, when the presentation unit 52 presents five handling methods, the selection unit 53 may extract an engineer who has experience of three or more handling methods from among the five handling methods. The selection unit 53 may assign a weight value to each of the handling methods presented by the presentation unit 52, and may extract an engineer with the sum of weight values of the handling methods of which the engineer has experience exceeding a threshold. For example, the selection unit 53 may assign a greater weight value to a handling method with greater frequency. The selection unit 53 may classify the handling methods presented by the presentation unit 52 into handling methods of which experience is indispensable and handling methods of which experience is arbitrary, and may extract an engineer who has indispensable experience of the handling methods. Here, the aforementioned selection of the engineer who handles the fault made by the selection unit 53 is illustrative, and the selection unit 53 may select an engineer based on various standards according to the occurred fault and an object of the handling.

When a plurality of engineers are selected, the selection unit 53 may prioritize the plurality of extracted engineers. In this case, the selection unit 53 may assign higher priority to an engineer with longer activity time from time when the fault occurs. For example, when the fault occurs at 13:00 (JST) and the engineer of T01 and the engineer of T03 are extracted as the engineer, first priority may be assigned to the engineer of T03 with longer activity time from 13:00 (JST). When the presentation unit 52 presents a plurality of handling methods, the selection unit 53 may assign higher priority to an engineer who has greater experience of the presented handling method. The selection unit 53 may assign higher priority to an engineer who has larger sum of weight values of the handling method for which the engineer has experience. Note that the aforementioned prioritization of the engineers who handle the fault performed by the selection unit 53 is illustrative, and the selection unit 53 may prioritize the engineers based on various standards according to the occurred fault and the object of the handling.

When a fault occurs in a certain country and the presentation unit 52 presents a handling method included in the handling candidate information of another country, the selection unit 53 selects an engineer who is capable of handling the fault from among engineers who belong to the country in which the fault occurs. For example, when a fault that occurs in the country C is stop of the server 13 and the presentation unit 52 presents a handling method for a case where the server 13 stops in the country B, based on the presented handling method, the selection unit 53 selects an engineer who is capable of handling the fault from among engineers who belong to the country C.

Flow of Processing

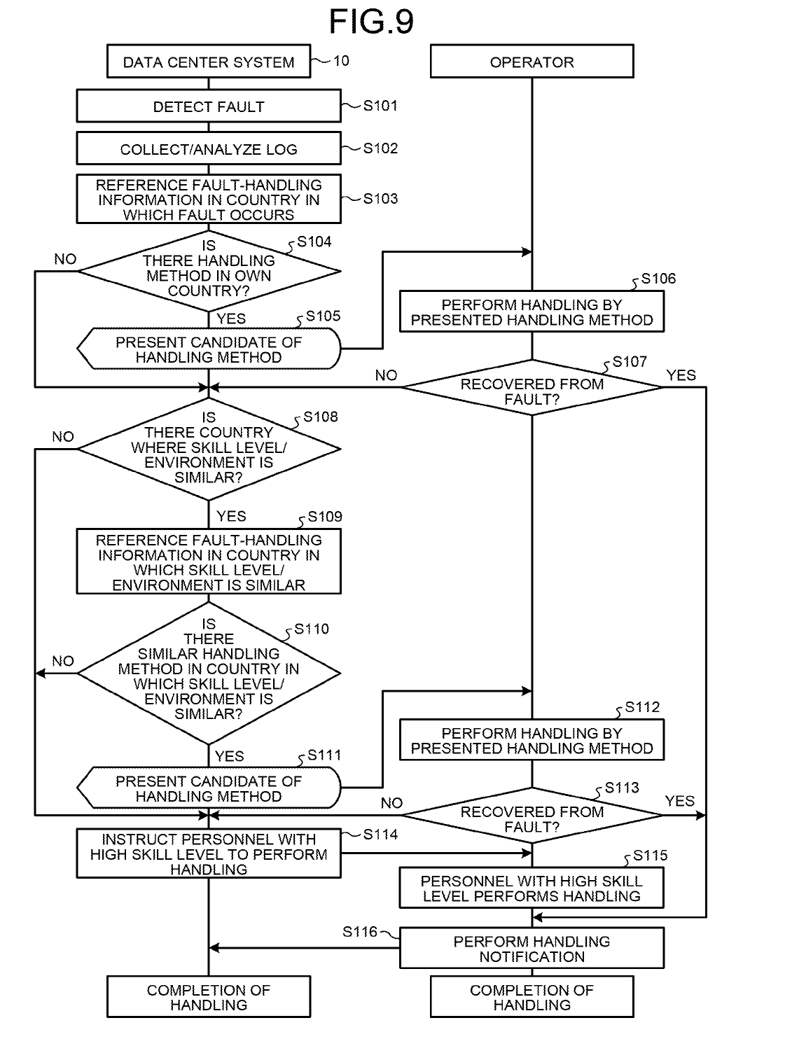

Next, a flow of fault-handling processing performed by the information processing apparatus 14 in a case where a fault occurs in the data center system 10 according to the embodiment will be described. FIG. 9 is a sequence diagram illustrating an example of a procedure of the fault-handling processing. This fault-handling processing is performed when a fault occurs in the data center system 10.

As illustrated in FIG. 9, the detection unit 50 of the information processing apparatus 14 detects occurrence of the fault in the data center 11 (step S101). The detection unit 50 that detects the occurrence of the fault in the data center 11 collects and analyzes a log of the occurred fault (step S102). Subsequently, based on the fault estimated by the detection unit 50, the extraction unit 51 references the fault-handling information in the country in which the fault occurs (step S103). For example, the extraction unit 51 extracts a handling method in the country in which the fault occurs from the fault-handling information corresponding to the occurred fault.

Next, when there is a handling method in the country in which the fault occurs (hereinafter referred to as “own country”) (step S104: Yes), the presentation unit 52 presents a candidate of the handling method in its own country (step S105). Subsequently, based on the candidate of the handling method presented by the presentation unit 52, the operator of the information processing apparatus 14 performs handling by the presented handling method (step S106). For example, the operator of the information processing apparatus 14 selects an engineer who performs the presented handling method, and causes the selected engineer to perform the handling. Here, the selection of the engineer who performs the handling method in step S106 may be performed by the information processing apparatus 14. When fault-recovery is made by performance of the handling in step S106 (step S107: Yes), the processing is finished as completion of handling (step S116).

When there is no handling method in its own country (step S104: No), the presentation unit 52 determines whether there is any country in which the skill level or environment, that is, the technical level is similar (step S108). Also, when the fault-recovery is not made by performance of the handling in step S106 (step S107: No), the presentation unit 52 determines whether there is any country in which the skill level or environment, that is, the technical level is similar (step S108). When there is a country in which the skill level or environment is similar (step S108: Yes), the presentation unit 52 references the fault-handling information in the country in which the skill level/environment is similar (step S109). For example, the presentation unit 52 instructs the extraction unit 51 to extract the handling method in the country in which the skill level/environment is similar from the fault-handling information corresponding to the occurred fault.

When there is a similar handling method in the country in which the skill level/environment is similar (step S110: Yes), the presentation unit 52 presents the candidate of the handling method in the country in which the skill level/environment is similar (step S111). The similar handling method mentioned here includes an identical handling method and a handling method with details of work having similarity. For example, in the example illustrated in FIG. 4, D201 “repair/replacement of the router” and D202 “repair/replacement of the hub” may be considered similar handling methods. Subsequently, based on the candidate of the handling method presented by the presentation unit 52, the operator of the information processing apparatus 14 performs the handling by the presented handling method (step S112). For example, the operator of the information processing apparatus 14 selects the engineer who performs the presented handling method, and causes the selected engineer to perform the handling. Here, the selection of the engineer who performs the handling method in step S112 may be performed by the information processing apparatus 14. When the fault-recovery is made by performance of the handling in step S112 (step S113: Yes), the operator of the information processing apparatus 14 performs handling notification to the data center system 10 (step S116), and finishes the fault-handling processing as completion of handling.

When there is no country in which the skill level/environment is similar (step S108: No), or when there is no similar handling method in the country in which the skill level/environment is similar (step S110: No), the presentation unit 52 instructs personnel with a high skill level to perform the handling (step S114). For example, the presentation unit 52 presents an engineer who has experience and skill of a plurality of handling methods in the data center system 10 as the engineer with a high skill level. Also, when the fault-recovery is not made by performance of the handling in step S112 (step S113: No), the presentation unit 52 instructs the personnel with a high skill level to perform the handling (step S114).

After the presentation unit 52 instructs the personnel with a high skill level to perform the handling in step S114, the operator instructs the personnel with a high skill level presented by the presentation unit 52 to perform the handling (step S115). For example, the operator of the information processing apparatus 14 selects the personnel with a high skill level presented by the presentation unit 52 as the engineer to perform the handling, and causes the selected engineer to perform the handling. Here, the selection of the engineer who performs the handling method in step S115 may be performed by the information processing apparatus 14. Subsequently, the operator of the information processing apparatus 14 performs handling notification to the data center system 10 (step S116), and finishes the fault-handling processing as completion of handling.

When the lead information processing apparatus 14 performs the processing other than detection of the fault of S101 in the data center system 10, each of the other information processing apparatuses 14 that detects the fault in S101 transmits information regarding the fault, such as the log information of the fault, to the lead information processing apparatus 14. In this case, the lead information processing apparatus 14 that receives the information regarding the fault, such as the log information of the fault, may perform the processing after S102.

### Advantageous Effects

As described above, the information processing apparatus 14 according to the present embodiment detects a fault that occurs in data centers 11 which are placed in a plurality of locations and are communicative with each other. When there is information regarding a handling method on occurrence of the fault in the past in the data center 11 in which the fault occurs, the information processing apparatus 14 presents the information regarding the handling method. When there is no information regarding the handling method, the information processing apparatus 14 presents information regarding the handling method on occurrence of the fault in the past in another data center 11. This allows the information processing apparatus 14 to expedite handling of the fault that occurs in the data center 11.

When there is no information regarding the handling method on occurrence of the fault in the past in the data center 11 in which the fault occurs, the information processing apparatus 14 according to the present embodiment presents information regarding the handling method on occurrence of the fault in the past in another data center 11 included in an area that has a technical level similar to a technical level of an area that includes the data center 11 in which the fault occurs. This allows the information processing apparatus 14 to expedite handling of the fault that occurs in the data center 11 by presenting the handling method on occurrence of the fault in the past in another data center 11 included in the area in which the technical level is similar.

When there is no information regarding the handling method on occurrence of the fault in the past in the data center 11 in which the fault occurs, based on the technical level that matches the fault among a plurality of technical levels that respectively match a plurality of faults, the information processing apparatus 14 according to the present embodiment presents information regarding the handling method on occurrence of the fault in the past in another data center 11 included in the area that has the technical level similar to the technical level of the area including the data center 11 in which the fault occurs. This allows the information processing apparatus 14 to expedite handling of the fault that occurs in the first data center 11 by presenting the handling method on occurrence of the fault in the past in another data center 11 included in the area in which the technical level regarding the occurred fault is similar.

The information processing apparatus 14 according to the present embodiment selects an engineer who is capable of handling the fault detected by the detection unit 50, based on the information regarding the handling method presented by the presentation unit 52 and on information regarding the engineer stored in the storage unit 30. This allows the information processing apparatus 14 to expedite handling of the fault that occurs in the data center 11.

Each illustrated component of each apparatus is functionally conceptual and does not necessarily need to be physically configured as illustrated. That is, specific condition of distribution and integration of each apparatus is not limited to the illustrated condition. All or part of the apparatuses may be configured in a functionally or physically distributed or integrated manner in arbitrary units according to various loads, usage conditions, etc. For example, each processor of the detection unit 50, extraction unit 51, presentation unit 52, and selection unit 53 may be integrated as appropriate. Processing of each processor may be divided into processing of a plurality of processors as appropriate. Furthermore, all or arbitrary part of processing functions respectively performed by the processors may be implemented by a CPU and a program that is analyzed and executed by the CPU, or may be implemented as hardware including wired logic.

Information Processing Program

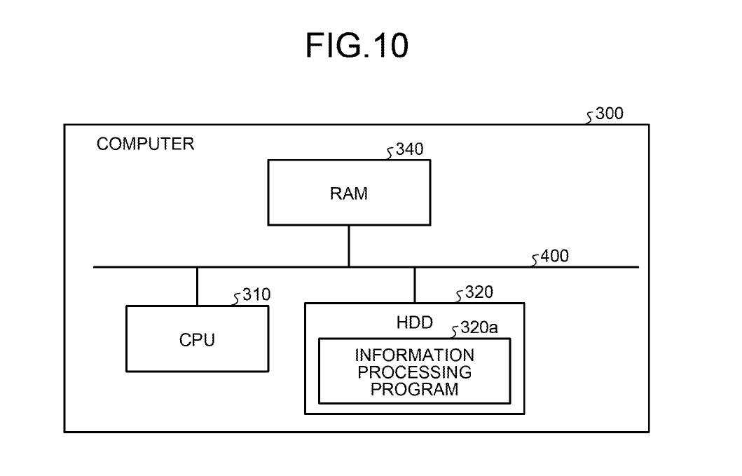

Various processes described in the aforementioned embodiment may also be implemented through execution of a program prepared in advance by a computer system such as a personal computer and a workstation. Therefore, the following describes an example of a computer system that executes a program that has a function similar to the function of the aforementioned embodiment. FIG. 10 is a diagram illustrating a computer that executes an information processing program.

As illustrated in FIG. 10, a computer 300 includes a CPU (Central Processing Unit) 310, an HDD (Hard Disk Drive) 320, and a RAM (Random Access Memory) 340. Each unit of the CPU 310, HDD 320, and RAM 340 is connected via a bus 400.

The HDD 320 previously stores an information processing program 320a that performs functions similar to the functions of the aforementioned detection unit 50, extraction unit 51, presentation unit 52, and selection unit 53. Note that the information processing program 320a may be separated as appropriate.

The HDD 320 stores various pieces of information. For example, the HDD 320 stores various pieces of data used for OS or production planning.

The CPU 310 reads and executes the information processing program 320a from the HDD 320 to perform operations similar to the operations of respective processors of the embodiment. That is, the information processing program 320a performs operations similar to the operations of the detection unit 50, extraction unit 51, presentation unit 52, and selection unit 53.

Here, the aforementioned information processing program 320a does not necessarily need to be stored in the HDD 320 from the beginning.

For example, the program is stored in a “portable physical medium”, such as a flexible disk (FD), CD-ROM, DVD disc, magneto-optical disc, and IC card to be inserted in the computer 300. The computer 300 may read the program from such a portable physical medium and execute the program.

Furthermore, the program is stored in “another computer (or server)”, etc. connected to the computer 300 via a public network, the Internet, LAN, WAN, etc. The computer 300 may read and execute the program from another computer, etc.

According to one aspect of the present invention, handling of the fault that occurs in the data center may be expedited.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a detection unit that detects a fault that occurs in a first data center among a plurality of data centers placed in a plurality of locations, the plurality of data centers being communicative with each other;
a storage unit that stores fault-handling information regarding a handling method of a fault that occurred in a past; and
an extraction unit that extracts, when the fault-handling information includes information regarding the handling method which is adapted in the past to address the detected fault occurred in the first data center, the information regarding the handling method, and extracts, when the fault handling information does not include the information regarding the handling method, information regarding the handling method which is adapted in the past to address the detected fault occurred in a second data center which is one of the plurality of data centers other than the first data center.

2. The information processing apparatus according to claim 1, wherein,
the extraction unit extracts, when the fault-handling information does not include the information regarding the handling method, the information regarding the handling method which is adapted in the past to address the detected fault occurred in the second data center included in an area that has a technical level similar to a technical level of an area including the first data center.

3. The information processing apparatus according to claim 2, wherein,
the extraction unit extracts, when the fault-handling information does not include the information regarding the handling method, the information regarding the handling method based on a technical level corresponding to the detected fault among a plurality of technical levels respectively corresponding to a plurality of faults.

4. The information processing apparatus according to claim 1, further comprising
a selection unit that selects an engineer who is capable of handling the fault detected by the detection unit, based on the information regarding the handling method extracted by the extraction unit, and on information regarding the engineer stored in the storage unit.

5. A non-transitory computer-readable recording medium having stored therein a program that causes a computer to execute a process comprising:
detecting a fault that occurs in a first data center among a plurality of data centers placed in a plurality of locations, the plurality of data centers being communicative with each other;
extracting from fault-handling information stored in a storage unit regarding a handling method of a fault that occurred in a past, when the fault-handling information includes information regarding the handling method which is adapted in the past to address the detected fault occurred in the first data center, the information regarding the handling method; and
extracting from the fault-handling information, when the fault-handling information does not include the information regarding the handling method, information regarding the handling method which is adapted in the past to address the detected fault occurred in a second data center which is one of the plurality of data centers other than the first data center.

6. The non-transitory computer-readable recording medium according to claim 5, wherein,
the extracting extracts, when the fault-handling information does not include the information regarding the handling method, the information regarding the handling method which is adapted in the past to address the detected fault occurred in the second data center included in an area that has a technical level similar to a technical level of an area including the first data center.

7. The non-transitory computer-readable recording medium according to claim 6, wherein,
the extracting extracts, when the fault-handling information does not include the information regarding the handling method, the information regarding the handling method based on a technical level corresponding to the detected fault among a plurality of technical levels respectively corresponding to a plurality of faults.

8. The non-transitory computer-readable recording medium according to claim 5, wherein the process further comprising
selecting an engineer who is capable of handling the fault detected in the detecting, based on the information regarding the handling method extracted in the extracting, and on information regarding the engineer stored in the storage unit.

9. An information processing method that causes a computer to execute a process comprising:
detecting a fault that occurs in a first data center among a plurality of data centers placed in a plurality of locations, the plurality of data centers being communicative with each other;
extracting from fault-handling information stored in a storage unit regarding a handling method of a fault that occurred in a past, when the fault-handling information includes information regarding the handling method which is adapted in the past to address the detected fault occurred in the first data center, the information regarding the handling method; and
extracting from the fault-handling information, when the fault-handling information does not include the information regarding the handling method, information regarding the handling method which is adapted in the past to address the detected fault occurred in a second data center which is one of the plurality of data centers other than the first data center.

10. The information processing method according to claim 9, wherein,
the extracting extracts, when the fault-handling information does not include the information regarding the handling method, the information regarding the handling method which is adapted in the past to address the detected fault occurred in the second data center included in an area that has a technical level similar to a technical level of an area including the first data center.

11. The information processing method according to claim 10, wherein,
the extracting extracts, when the fault-handling information does not include the information regarding the handling method, the information regarding the handling method based on a technical level corresponding to the detected fault among a plurality of technical levels respectively corresponding to a plurality of faults.

12. The information processing method according to claim 9, further comprising
selecting an engineer who is capable of handling the fault detected in the detecting, based on the information regarding the handling method extracted in the extracting, and on information regarding the engineer stored in the storage unit.

13. A data center system comprising:
a plurality of data centers placed in a plurality of locations and communicative with each other; and
an information processing apparatus, the information processing apparatus comprising:
a detection unit that detects a fault that occurs in a system that is operated in each of the plurality of data centers;
a storage unit that stores fault-handling information regarding a handling method of a fault that occurred in a past; and
an extraction unit that extracts, when the fault-handling information stored in the storage unit includes information regarding the handling method which is adapted in the past to address the detected fault occurred in a first data center among the plurality of data centers, the information regarding the handling method, and extracts, when the fault-handling information does not include the information regarding the handling method, information regarding the handling method which is adapted in the past to address the detected fault occurred in a second data center which is one of the plurality of data centers other than the first data center.

14. The data center system according to claim 13, wherein,
the extraction unit extracts, when the fault-handling information does not include the information regarding the handling method, the information regarding the handling method which is adapted in the past to address the detected fault occurred in the second data center included in an area that has a technical level similar to a technical level of an area including the first data center.

15. The data center system according to claim 14, wherein,
the extraction unit extracts, when the fault-handling information does not include the information regarding the handling method, the information regarding the handling method based on a technical level corresponding to the detected fault among a plurality of technical levels respectively corresponding to a plurality of faults.
